(19) United States
(12) Patent Application Publication
(10) Pub. No.: US 2026/0203827 A1
(43) Pub. Date: Jul. 16, 2026

(54) AI-DRIVEN SYSTEM FOR AUTOMATED CREATION AND OPTIMIZATION OF PHARMACY BENEFIT PLANS

(71) Applicant: Express Scripts Strategic Development, Inc., St. Louis, MO (US)

(72) Inventors: Sahaya Chitra Arputham, Cumming, GA (US); Moses Vaughan, Nutley, NJ (US)

(21) Appl. No.: 19/019,970

(22) Filed: Jan. 14, 2025

(51) Int. Cl. G06Q 40/08; G06Q 10/10

(52) U.S. Cl. CPC G06Q 40/08; G06Q 10/10; G06Q 40/082; G06Q 40/0821; G06Q 40/09

(57) ABSTRACT

AI-driven systems and methods for creating a customized pharmacy benefit plan for a client are provided. Historical claims data, transcripts or recordings of meetings between a pharmacy benefit manager (PBM) and the client, and survey data from members are received. The pharmacy benefit plan is generated by inputting the received data into a benefit plan model. The generated plan can be pressure tested using hypothetical claims or historical data to calculate the plan's impact and modifying the benefit plan model based on the calculated impact. Legislative or regulatory requirements, forecasted future medication needs, and constraints on the benefit plan, including client profitability requirements also can be received and used to generate the plan. The generated pharmacy benefit plan may include medication co-pay amounts, deductible amounts, claim adjudication rules, covered medications, and covered medical treatments.

### BACKGROUND

Pharmacy benefit plans are healthcare plans or components of health insurance policies that provide coverage for prescription medications. These plans are typically managed by specialized entities or health insurance companies. The purpose of these plans is to help plan members access and afford necessary medications while managing overall drug costs for the insurer and employer. The creation and management of these plans involve defining which medications are covered, determining cost-sharing mechanisms, and managing formularies and network pharmacies.

The process of setting up and managing pharmacy benefit plans is complex and time-consuming. This often requires extensive meetings with clients to document their benefit design, followed by the implementation of these designs in multiple systems. This process can take several months to a year, involving significant investment in technology and ongoing maintenance. The variability in client configurations and claim adjudication rules further complicates the process, leading to inefficiencies and potential misinterpretations. Additionally, the need to update benefit plans in response to legislative changes, regulatory requirements, and client needs adds to the complexity and time required for plan management.

### BRIEF SUMMARY

In one example, a method for creating a customized pharmacy benefit plan for a client using an artificial intelligence (AI) system is provided. The method can include receiving, by the AI system, historical claims data from previous benefit plans; receiving, by the AI system, transcripts or recordings of meetings between a pharmacy benefit manager (PBM) and the client; receiving, by the AI system, survey data from members to gather member plan preferences and member plan requirements; and generating, by the AI system inputting the historical claims data, the transcripts or the recordings, and the survey data into a benefit plan model, the pharmacy benefit plan that dictates pharmacy benefits for the members.

An application-specific integrated circuit (ASIC) for an artificial neural network (ANN) is provided. The ASIC can include neurons organized in an array, each of the neurons including a register, a processing element, and at least one input; and synaptic circuits, each of the synaptic circuits including a memory for storing a synaptic weight, wherein each of the neurons is connected to at least one other of the neurons via at least one of the synaptic circuits. The processing elements of the neurons can be configured to receive historical claims data from previous benefit plans; receive transcripts or recordings of meetings between a pharmacy benefit manager (PBM) and the client; receive survey data from members to gather member plan preferences and member plan requirements; and generate the pharmacy benefit plan that dictates pharmacy benefits for the members by inputting the historical claims data, the transcripts or the recordings, and the survey data into a benefit plan model.

A machine-readable medium storing instructions for generating customized pharmacy benefit plans for clients is provided. The instructions, when executed, can cause a machine to perform operations comprising receiving historical claims data from previous benefit plans; receiving transcripts or recordings of meetings between a pharmacy benefit manager (PBM) and the client; receiving legislative and regulatory requirements; receiving forecasted future medication needs based on demographic information; receiving survey data from members to gather their preferences and requirements; receiving constraints on the benefit plan, including profitability requirements and client-specific needs; processing the received data using an AI model to generate a benefit plan, the benefit plan comprising co-pay amounts; deductible amounts; rules or criteria for adjudicating claims; lists of covered medications and treatments; prescription sizes; indications of whether medications can be mailed or must be picked up at a pharmacy; lists of approved pharmacies, healthcare providers, and distributors; pressure testing the generated benefit plan using hypothetical claims and demographic information to ensure cost-effectiveness and feasibility; and outputting the generated and pressure-tested benefit plan.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of example, and not limitation, in the figures of the accompanying drawings in which:

FIG. 1 illustrates one example of an AI system for generating cost-optimized, customized benefit plans;

FIG. 2 illustrates a flowchart of one example of a method for generating and optimizing pharmacy benefit plans using AI;

FIG. 3 illustrates one example of a machine learning (ML)/AI system;

FIG. 4 illustrates one example of a PBM system shown in FIG. 1 as a high-volume pharmacy;

FIG. 5 illustrates a pharmacy fulfillment device shown in FIG. 4 according to one example; and

FIG. 6 illustrates one example of an order processing device shown in FIG. 4.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Pharmacy benefit plans can be intricate and require significant time and resources to develop. These plans, which provide coverage for prescription medications, are typically managed by pharmacy benefit managers (PBMs) or health insurance companies. The complexity of these plans arises from the need to balance cost management for insurers and employers (e.g., clients of the PBMs) with accessibility and affordability for members (e.g., employees of the employers or insured persons). The process of creating these plans can involve defining covered medications, establishing cost-sharing mechanisms, and managing formularies, among other tasks, while also focusing on constraints such as profitability goals of the clients, legislative or regulatory requirements, etc.

Current methods for developing pharmacy benefit plans can be labor-intensive and time-consuming. The process often involves extensive meetings between PBMs and clients to document benefit design intentions. This documentation process is prone to misinterpretation and inefficiencies, leading to delays and inconsistent implementations. Additionally, the manual nature of the process requires significant investment in technology and operational resources, further complicating the onboarding of new clients and the maintenance of existing plans. These challenges can prevent clients from re-evaluating and modifying benefit plans very often, which can be problematic in view of changing economic conditions, natural disasters (where a change in a benefit plan to help members suffering loss from the natural disasters is needed), etc.

The disclosed systems and methods address these challenges by leveraging an AI system to create customized pharmacy benefit plans. The AI system receives various inputs, including historical claims data, transcripts or recordings of meetings between PBMs and clients, and survey data from members. By processing these inputs through a benefit plan model, the AI system generates a pharmacy benefit plan that dictates pharmacy benefits for members. This approach streamlines the creation and modification of benefit plans, reducing the time and resources required while ensuring alignment with client goals and member preferences.

By utilizing an AI system to receive and process historical claims data, transcripts or recordings of meetings, and survey data, the system and method can create a customized pharmacy benefit plan that is tailored to the specific needs and preferences of the client and its members. This approach significantly reduces the time and effort required to design benefit plans compared to traditional manual methods, which are often time-consuming and prone to errors. For example, the AI system or method can create a new benefit plan in seconds to minutes, whereas manually creating the same plan may take many months to complete.

The ability of the AI system to integrate diverse data sources, such as historical claims data, client meeting transcripts, and surveys of members ensures that the generated benefit plan is both comprehensive and aligned with the client's goals and member requirements. This leads to more accurate and effective benefit plans that can better manage drug costs while meeting the needs of the members.

Additionally, the use of survey data to gather member preferences and requirements allows the AI system to incorporate the “voice of the people” into the benefit plan design. This ensures that the benefit plan is not only cost-effective but also responsive to the actual needs and desires of the members, thereby improving member satisfaction and adherence to the plan.

Overall, the systems and methods enhance the efficiency and accuracy of creating pharmacy benefit plans, allowing for more frequent updates and modifications in response to changing conditions, such as new legislative requirements or shifts in member needs. This flexibility and responsiveness can help maintain the relevance and effectiveness of the benefit plans over time.

While examples are provided discussing the AI-driven creation of benefit plans, not all embodiments of the inventive subject matter described herein are limited to pharmacy benefit plans. The inventive subject matter can be adapted for use in various other industries such as restaurant planning, grocery store planning, and vehicle design. In restaurant planning, the AI system can analyze consumer trends, crop shortages, and changes in food prices to recommend menu adjustments that align with customer preferences and optimize costs. For grocery store planning, the system can process data on supply chain fluctuations, consumer buying patterns, and seasonal trends to optimize inventory management and shelf space allocation. In the automotive industry, the AI system can evaluate changing consumer tastes, upcoming tariffs on materials, and technological advancements to suggest new car designs that meet market demands and regulatory requirements. By leveraging its ability to integrate diverse data sources and generate optimized plans, the AI system can provide valuable insights and recommendations across various sectors, enhancing efficiency, cost-effectiveness, and customer satisfaction.

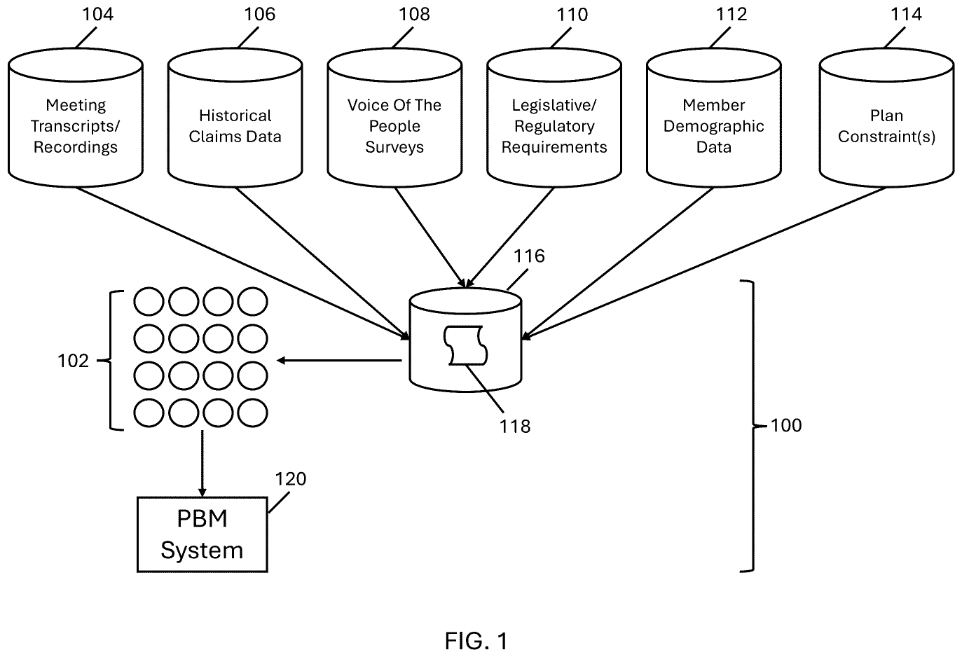

FIG. 1 illustrates one example of an AI system 100 for generating cost-optimized, customized benefit plans. The AI system 100 includes several interconnected components that work together to create a customized pharmacy benefit plan for a client using one or more AI systems. A control unit 102 of the AI system 100 operates as the central processing unit of the AI-driven system 100. The control unit 102 can represent or include a variety of advanced hardware and software components. The control unit 102 may include one or more high-performance microprocessors or multi-core processors capable of handling complex computations and large datasets efficiently. Optionally, the control unit 102 can represent one or more ASICs that form a neural network, machine learning system, etc., as the AI system 100.

The control unit 102 can include a substantial amount of RAM and storage capacity to manage and process the extensive data inputs required for generating customized benefit plans. Additionally, the control unit 102 might incorporate specialized AI accelerators, such as graphics processing units (GPUs) or tensor processing units (TPUs), to enhance the speed and efficiency of machine learning algorithms. On the software side, the control unit 102 could run sophisticated AI and machine learning frameworks, such as TensorFlow or PyTorch, to facilitate the development and execution of the benefit plan models. Furthermore, the control unit 102 could include secure communication interfaces to ensure the safe transfer of sensitive data between various databases and the pharmacy benefit management system.

Several databases 104, 106, 108, 110, 112, 114 may provide data to the control unit 102 to allow the control unit 1012 to build a customized benefit plan. The databases 104, 106, 108, 110, 112, 114 can represent tangible and non-transitory computer-readable storage media owned and/or controlled by one or more parties, entities, companies, etc. to generate, store, and communicate the information described in connection with each of the databases 104, 106, 108, 110, 112, 114. The databases 104, 106, 108, 110, 112, 114 can represent one or more structured data repositories that store and manage different kinds of information used by the AI-driven system 100 to create and/or modify benefit plans. For example, the databases 104, 106, 108, 110, 112, 114 can represent servers, computer hard drives, removable drives, optical drives, etc. Two or more of the databases 104, 106, 108, 110, 112, 114 can be combined into a single database.

A transcript/recording database 104 can store transcripts, audio recordings, and/or video recordings of meetings between a PBM and the client. These meetings (represented by the data stored in the database 104) can capture detailed discussions about client requirements and preferences. A claims database 106 can hold historical claims data. The claims database 106 can store information representing past usage of benefits provided under a benefit plan. The claims data can be information about claims submitted for benefits by the members under a current or former benefit plan. For example, the claims database 106 can store information such as medication names, medication quantities, medication costs, patient demographics, and treatment outcomes. The claims data also include patient demographic information associated with the claims, such as the patient's name, date of birth, gender, and address. The claims data can include an identifier of the benefit plan, group number, or the like. The healthcare provider or prescribing physician may be identified in the claims data as well. This information can be helpful in evaluating how much the members utilize the current or prior benefit plan, as well as the medication or treatment amounts or frequencies associated with benefits provided under the plan.

A survey database 108 can contain survey data from members. These surveys may ask members for responses or input on the preferences of the members for the new or updated benefit plan, satisfaction ratings of the prior or current benefit plan, feedback on co-pay and deductible amounts, selections of medications and/or treatments desired by the members to be associated with benefits under the plan, etc. The survey database 108 can include a range of data points, such as member satisfaction ratings with current benefit plans (which can provide information on how well the existing plans meets the needs of members), feedback on co-pay and deductible amounts (to identify amounts that are burdensome for members and/or where adjustments could be less burdensome), specific requests for medications and treatments that members would like to see covered in the benefit plan. The survey database 108 can store data on demographic information of the survey respondents (e.g., age, gender, and health conditions). This can allow the other survey responses to be correlated with specific sets of the members (e.g., different age groups, different living areas such as urban versus rural, etc.).

A legislative/regulatory database 110 can store legislative or regulatory requirements. These requirements can include law and regulations applicable in different jurisdictions that may require benefit plans to include certain features, coverages, etc., or that prohibit benefit plans from having certain features, coverages, etc. The AI-drive system 100 can use this information to ensure that the generated benefit plans comply with applicable laws.

A member database 112 can include demographic data about the members, such as age, gender, and health conditions. This information can be used by the AI-driven system 100 (e.g., by the control unit 102) to forecast future medication needs, which can impact the benefits and/or adjudication criteria of the benefit plan that will be created. A constraint database 114 can store data indicative of constraints on the benefit plan. These constraints may be rules or requirements that differ from the regulatory and/or legislative requirements. For example, the constraints on the plan can include a profitability goal of the client. This goal may require that the cost to the client for the benefit plan be below a set amount. Other constraints can include client-specific needs, which can be requirements dictated by the client (such as that the plan provide benefits for certain medications or treatments, that the plan not provide benefits for certain medications or treatments, or the like).

The AI-driven system 100 can include a model database 116 that represents one or more tangible and non-transitory computer-readable storage media, such as one or more computer hard drives, servers, optical drives, removable drives, etc. The model database 116 can store a benefit plan model 118 that is used by the control unit 102 of the AI-driven system 100 to generate the customized benefit plans. The model database 116 also can store the generated benefit plans for examination, pressure-testing, and implementation.

In one example, the control unit 102 can be an ASIC that operates as an AI system, machine learning system, or artificial neural network (ANN) system that generates the benefit plans using the data obtained from one or more of the databases 104, 106, 108, 110, 112, 114. The data can be communicated from the databases 104, 106, 108, 110, 112, and/or 114 to the model database 116 (via one or more computerized communication networks, such as the Internet, Local Area Networks, intranets, etc.). The control unit 102 can input this data into the model database 116, and the model database 116 can examine the data and generate a benefit plan for examination, potential pressure-testing, and potential implementation, as described herein.

A pharmacy benefit management (PBM) system 120 can represent hardware circuitry that includes and/or is connected with one or more processors (e.g., one or more integrated circuits, ASICs, field programmable gate arrays, microprocessors, or the like) that can pressure-test and/or implement the benefit plan that is created. For example, the PBM system 120 can apply the benefit plan that is generated to hypothetical claims and/or claims from the claims database 106. The benefit plan can be applied to the claims by examining how the claims would be handled if the benefit plan were implemented. This can include calculating the costs to the members for submitting the hypothetical and/or historical claims based on the generated benefit plan, calculating the costs to the client if the members were to submit the hypothetical and/or historical claims for benefits under the generated plan, and so on. The pharmacy benefit management system 120 can correctly and efficiently apply the benefit plan and efficiently to provide members with the specified benefits and managing overall drug costs for the insurer and employer.

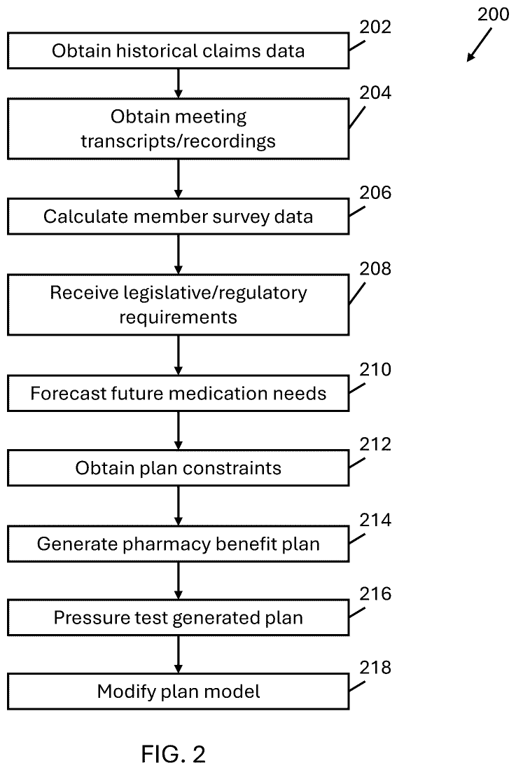

FIG. 2 illustrates a flowchart of one example of a method 200 for creating a customized benefit plan. The method 200 can represent operations performed by the AI-driven system 100, including the control unit 102. The method 200 can be used to create a customized pharmacy benefit plan for a client using the AI-driven system 100. At 202, historical claims data 202 is obtained. The historical claims data can be communicated from previous benefit plans and/or benefit manager systems. The data can include detailed information about past claims, such as the number of claims for specific medications, the associated costs, patient demographics, and treatment outcomes. The historical claims data can provide a foundational dataset that informs the AI-driven system 100 about patterns and/or trends in medication usage and costs by the members or potential members of the plan that is being generated.

At 204, meeting transcripts or recordings are obtained. The AI system 100 can receive the transcripts or recordings of meetings between the PBM and the client. These transcripts or recordings can capture the discussions and negotiations regarding the client's requirements, preferences, and goals for the new benefit plan. The transcripts or recordings can be used to understand the specific needs and priorities of the client and help ensure that the generated benefit plan aligns with the client's expectations.

At 206, member survey data is calculated. This can involve receiving the results of surveys or questionnaires submitted to the members and examining the results. For example, the surveys can inquire as to what medications the members would like to be covered under the benefit plan (with the members receiving benefits or more benefits for medications that are covered relative to other medications). This surveys can include member satisfaction ratings with current benefit plans, feedback on co-pay and deductible amounts, and other preferences related to the benefit plan. The survey data can be calculated to identify more prevalent requests. For example, the survey data can be calculated to determine which medications, treatments, or benefits are requested more often than other medications, treatments, or benefits.

At 208, legislative or regulatory requirements are obtained. The AI system 100 can receive these requirements for benefit plan coverage from legal publications, from legal service providers (e.g., law firms), from industry publications, or from user input. These requirements may include updates to state or federal regulations related to benefit plan coverage over time. The legislative or regulatory requirements can be received and input into the benefit plan model 118 so that the generated pharmacy benefit plan complies with all applicable laws and regulations.

While the operations described in connection with 202, 204, 206, 208 are shown in a sequential order in FIG. 2, one or more of these operations may be skipped and/or the order in which the operations are performed may be swapped. In another example, two or more of the operations of 202, 204, 206, 208 may be performed concurrently or simultaneously.

At 210, future medication needs are forecasted. The control unit 102 can calculate the forecasted future medication needs of the members based on demographic trends and/or emerging health conditions. The future medication needs that are forecasted can be estimates for how many members are likely to require certain medications or medical treatments, how much of these medications or medical treatments that the members are likely to require, how long the members will require the medications or medical treatments, and so on.

For example, the control unit 102 can calculate the forecasted future medication needs of the members based on demographic data about the members, such as age, gender, weight, alcohol use, smoker or non-smoker indication, and locations. A member population that is older, more overweight, includes more smokers, and/or predominantly resides in areas associated with poor diets and/or alcohol consumption may be forecasted to require more medications and/or treatments for diabetics than another member population that is younger, less overweight, has fewer smokers, and/or predominantly resides in areas associated with better diets and/or less alcohol consumption. The forecasts can be based on claims data from different member populations of the same and/or other pharmacy benefit manager and/or client. For example, historical claims data for different groups of patients can be examined over time to better predict the demographic makeup of different member populations associated with increased use of certain medications. By considering forecasted future medication needs, the method 200 can generate a benefit plan that anticipates and addresses the future healthcare requirements of the members.

At 212, plan constraints are obtained. These constraints may be communicated to the control unit 102 and/or can be input by a user (e.g., from the pharmacy benefit manager). The control unit 102 can receive constraints on the benefit plan, such as a client profitability requirement. These constraints may be dictated by the client's profitability targets, cost limits, and other specific needs. The constraints can be input into the benefit plan model to ensure that the generated pharmacy benefit plan meets the client's financial and strategic goals while remaining affordable for the end users.

At 214, the pharmacy benefit plan is generated. The AI system 100 (e.g., the control unit 102) can generate the pharmacy benefit plan by inputting the historical claims data, the transcripts or the recordings, the survey data, the legislative or regulatory requirements, the forecasted future medication needs, and/or the constraints into the benefit plan model 118. The benefit plan model 118 can output the plan, as described herein. The generated pharmacy benefit plan can dictate pharmacy benefits for the members, including medication co-pay amounts, deductible amounts, claim adjudication rules, covered medications, and covered medical treatments.

At 216, the generated plan optionally is pressure tested. The control unit 102 can pressure test the pharmacy benefit plan that is generated using one or more hypothetical pharmacy claims or the historical claims data to calculate a plan impact on the client. The impact can be the financial cost, the ability of the plan to meet the medical needs of the members, and the like, given different sets of hypothetical and/or historical claims input into the benefit plan. The control unit 102 can input an abnormally large number of claims and/or an abnormally difficult combination of claims for the plan to handle. The control unit 102 can calculate the client impact, such as the financial cost to implement the plan, given the hypothetical and/or historical claims that are input into the generated plan. This can help ensure that the generated benefit plan is cost-effective and feasible for the client under various scenarios. Optionally, the generated plan is not pressure tested.

At 218, the benefit plan model optionally is modified. The control unit 102 can change the benefit plan model 118 used to create the benefit plan based on the plan impact that is calculated during the pressure testing at 216. For example, if the cost to implement the plan is too great, if the claim adjudication rules or criteria conflict with each other and/or provide inconsistent decisions on whether claims are allowed or denied, if the benefit plan cannot reasonably be implemented to process the member claims in a timely manner (e.g., within seconds of the claims being submitted), or other problems or faults in the plan exist, then the control unit 102 can change one or more aspects of the benefit plan model 118 as described below. Modifying the model 118 can result in the model 118 outputting a different benefit plan given the same input as before. That is, the model 118 can be changed so that a different benefit plan is generated. Optionally, flow of the method 200 can return to one or more prior operations, such as 216 to pressure test the modified plan, or may terminate. The modified benefit plan model 118 can generate a different benefit plan responsive to the same historical claims data, the same transcripts or recordings, and the same survey data. This iterative process can allow the AI system 100 to refine and optimize the benefit plan to better meet the client's needs and constraints.

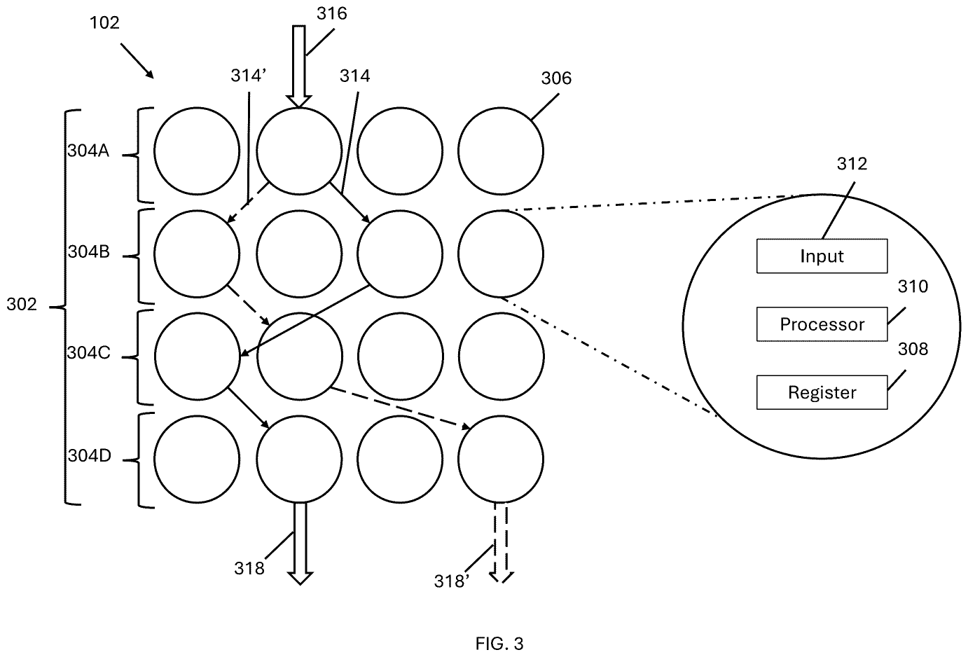

FIG. 3 illustrates one example of the control unit 102 shown in FIG. 1 implemented as an ANN, ML, and/or AI system. The control unit 102 can be embodied in one or more application-specific integrated circuits (ASICs) for an ANN. The control unit 102 can include a series 302 of layers 304A-D. Each layer 304A-D can include one or more artificial neurons 306 arranged in one or more neuron arrays or arrangements. While four neurons 306 are shown in each layer 304A-D and four layers 304A-D are shown, alternatively, a different number of neurons 306 may be in one or more of the layers 304A-D and/or there may be a different number of layers 304A-D.

The control unit 102 may include the neurons 306 arranged in an input layer 304A, an output layer 304D, and two or more fully connected hidden or intermediate layers 304B, 304C between the input and output layers 304A, 304D. Each neuron 306 can include or represent at least one register 308, at least one microprocessor 310, and at least one input 312. The neurons 306 can generate outputs based on one or more activation functions. The neurons 306 can receive input from another neuron 306 (e.g., the output from one neuron 306 can be the input for another neuron 306). This input also can include a set of weights. The neurons 306 can be connected with each other via synaptic circuits 314. The synaptic circuits 314 can include or represent memories for storing synaptic weights. The synaptic circuits 314, and mathematical equations and weights that define the synaptic circuits 314, can represent the benefit plan model 118 shown in FIG. 1.

The synaptic circuits 314 connecting the neurons 306 can be equipped with non-volatile memory elements, such as flash memory or phase-change memory, to store the synaptic weights. The processing elements 310 of the neurons 306 can receive historical claims data from previous benefit plans, transcripts or recordings of meetings between a PBM and the client, and survey data from members to gather member plan preferences and requirements. The ASIC 102 can process this data using the model 118 to generate a pharmacy benefit plan that dictates pharmacy benefits for the members by inputting the historical claims data, the transcripts or recordings, and the survey data into the benefit plan model 118. While the neurons 306 are shown in a two dimensional array, optionally, the neurons 306 may be arranged in a three-dimensional array to increase processing power and efficiency, with each neuron 306 connected to multiple synaptic circuits 314 that use dynamic random-access memory (DRAM) for faster data access and processing. Additionally, the processing elements 310 can handle real-time data inputs, allowing the ASIC 102 to dynamically adapt to changes in legislative or regulatory requirements and forecasted future medication. In yet another embodiment, the ASIC 120 can include specialized processing elements optimized for natural language processing (NLP) tasks, enabling more accurate interpretation of meeting transcripts and survey data to improve the customization and accuracy of the generated pharmacy benefit plans. The synaptic circuits 314 may utilize resistive random-access memory (ReRAM) to achieve higher density and lower power consumption and make the ASIC 102 suitable for deployment in portable or edge computing devices.

One or more neurons 306 in the input layer 304A of the control unit 102 can receive an input 316. The input 316 can include, for example, one or more of the meeting transcript/recording data, historical claims data, member surveys (or “voice of the people” surveys), legislative and/or regulatory requirements, member demographic data, and/or plan constraints. The neurons 306 can receive this input data 316 via the input(s) 312 of the neurons 306 in the input layer 304A. The neurons 306 receive the input data 316, apply one or more mathematical equations or relationships stored in the registers 308 (and that include the weights) to generate an output. The processors 310 of the neurons 306 apply the equations/relationships and can pass the output to another neuron 306 in the same layer 304A or in a different layer 304B, 304C. The output from one neuron 306 is passed along a synaptic circuit 314 to another neuron 306 and is used as input to this other neuron 306. This process continues until one or more neurons 306 in the output layer 304D generate an output 318 from the ML/AI system 300.

The synaptic circuits 314, weights stored in the synaptic circuits 314, and/or the mathematical relationships between the neurons 306 can define the benefit plan model 118. For example, the neurons 306 can examine the input data 316 and generate a benefit plan based on the input data 316 (e.g., the meeting transcript/recording data, historical claims data, member surveys, legislative and/or regulatory requirements, member demographic data, and/or plan constraints). The weights and mathematical equations applied to this data to determine which neuron 306 is to receive the output from a current neuron 306 can define the synaptic circuits 314, weights stored in the synaptic circuits 314, and/or the mathematical relationships between the neurons 306. The output 318 from the neurons 306 in the output layer 304D of the control unit 102 can include the benefit plan, such as the adjudication rules for claims, the copays, etc.

During training of the model 118, labeled data may be provided as the input data 316 to the model 118. The labeled data can include meeting transcript/recording data, historical claims data, member surveys, legislative and/or regulatory requirements, member demographic data, and/or plan constraints associated with (e.g., used in the creation of) different, previously created and/or used benefit plans (to the extent the data is available). The neurons 306 process the input data 316 to generate the training output of the model 118. This training output can be a benefit plan. Different combinations of input data 316 result in different benefit plans being output by the model 118. For example, one set of training data will result in one benefit plan being output, while another, different set of the training data will result in another, different benefit plan being output. The different benefit plans can have different claim adjudication rules or criteria, different copays, different deductibles, different coverages for different medications and treatments, etc.

Feedback can be provided to the control unit 102 and/or model 118 in the form of a calculated error or other indication of the differences between the benefit plans that are output from the model 118 based on the training data, and benefit plans that should have been output from the model 118 based on the training data. For example, for a set of data provided to the model 118 as the input 316, a benefit plan is output 318 from the model 118. This benefit plan can be compared with the actual benefit plan that was manually created over an extended period of time using the same data as was provided as input 316 into the model 118. The model-output benefit plan is compared with the manually created benefit plan to identify differences. These differences can be one or more different claim adjudication rules, different copay amounts, different medication coverages, different treatment coverages, different deductible amounts, and so on.

If the differences between these plans are greater, then a larger error is calculated. If the differences between the plans are lesser or smaller, then a smaller error is calculated. The error and/or differences are then provided back to the control unit 102, which can direct the neurons 306 to modify one or more of the synaptic circuits 314, the weights applied by one or more of the neurons 306, and/or the mathematical relationships between the neurons 306. For example, some synaptic circuits 314 can be changed to modified synaptic circuits 314′ such that the same input 316 would result in different neurons 306 receiving input and passing output to other neurons and generating a different output 318′ from the AI/ML system 300. As a result, changing one or more of these weights or relationships (e.g., synaptic circuits 314, 314′) also can change the benefit plan that is output by the model 118 (with the same input 316 as before). This process can be repeated through multiple iterations. The model 118 can be improved through these iterations to reduce the error or differences between the benefit plans created based on the training data and the plans previously created using the same training data.

After training the model 118, the control unit 102 can use the trained model 118 to generate benefit plans. During post-training iterations of operation of the model 118, additional feedback can be provided to the control unit 102 based on errors in the AI-created benefit plans. For example, after training, the AI-created benefit plans output from the model 118 can be examined to determine whether any undesirable features are included (e.g., medications not covered even though coverage requested by the client, adjudication rules that conflict with the meeting transcripts, deductible or co-pay amounts that exceed set thresholds, the plan is calculated as preventing the client from reaching a profitability target or goal during pressure testing of the plan, etc.). Error can then be provided back to the control unit 102 and the control unit 102 can continue re-training and refining the model 118 so that the model 118 improves in creating plans over time.

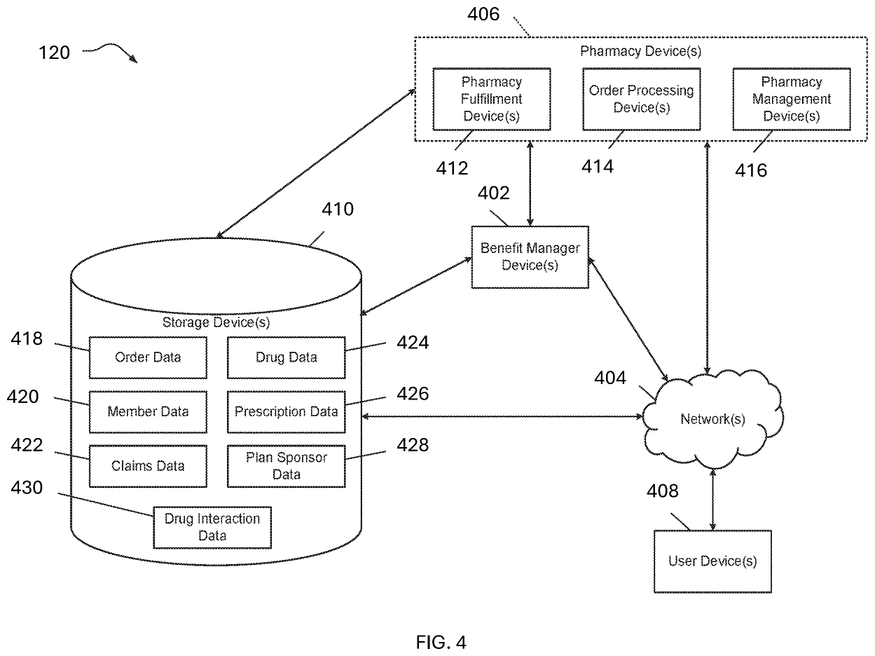

The benefit plans that are created can be pressure tested by the control unit 102, as described herein. Once a benefit plan is finalized, the benefit plan can be communicated from the control unit 102 to the PBM system 120 for implementation. In one example, the PBM system 120 may represent or include a high volume pharmacy. FIG. 4 illustrates one example of the PBM system 120 as a high-volume pharmacy. While the system 120 is generally described as being deployed in a high-volume pharmacy or a fulfillment center (for example, a mail order pharmacy, a direct delivery pharmacy, etc.), the system 120 and/or components of the system 120 may otherwise be deployed (for example, in a lower-volume pharmacy, etc.). A high-volume pharmacy may be a pharmacy that is capable of filling at least some prescriptions mechanically. The system 120 may include a benefit manager device 402 and a pharmacy device 406 in communication with each other directly and/or over a network 404. The system 120 may also include a storage device 410, which can be the same as or similar to one or more of the databases described herein.

The benefit manager device 402 is a device operated by an entity that is at least partially responsible for creation and/or management of the pharmacy or drug benefit. While the entity operating the benefit manager device 402 is typically a PBM, other entities may operate the benefit manager device 402 on behalf of themselves or other entities (such as PBMs). For example, the benefit manager device 402 may be operated by a health plan, a retail pharmacy chain, a drug wholesaler, a data analytics or other type of software-related company, etc. In some implementations, a PBM that provides the pharmacy benefit may provide one or more additional benefits including a medical or health benefit, a dental benefit, a vision benefit, a wellness benefit, a radiology benefit, a pet care benefit, an insurance benefit, a long term care benefit, a nursing home benefit, etc. The PBM may, in addition to its PBM operations, operate one or more pharmacies. The pharmacies may be retail pharmacies, mail order pharmacies, etc.

Some of the operations of the PBM that operates the benefit manager device 402 may include the following activities and processes. A member (or a person on behalf of the member) of a pharmacy benefit plan may obtain a prescription drug at a retail pharmacy location (e.g., a location of a physical store) from a pharmacist or a pharmacist technician. The member may also obtain the prescription drug through mail order drug delivery from a mail order pharmacy location, such as the system 120. In some implementations, the member may obtain the prescription drug directly or indirectly through the use of a machine, such as a kiosk, a vending unit, a mobile electronic device 408, or a different type of mechanical device, electrical device, electronic communication device, and/or computing device. Such a machine may be filled with the prescription drug in prescription packaging, which may include multiple prescription components, by the system 120. The pharmacy benefit plan can be created by the AI-driven system 100 and can be administered by or through the benefit manager device 402. Without the benefit plan created by the system 100, the PBM cannot or does not perform the operations described herein.

The user device 408 may be a stand-alone device that solely provides at least some of the functionality to enable augmented reality, or may be a multi-use device that has functionality outside of augmented reality functions as described herein. Examples of the user device 408 include a set-top box (STB), a receiver card, a mobile telephone, a personal digital assistant (PDA), a display device, a portable gaming unit, and a computing system; however, other devices may also be used. For example, the user device 408 may include a mobile electronic device, such an IPHONE or IPAD device by Apple, Inc., mobile electronic devices powered by ANDROID by Google, Inc., etc. The user device 408 also include other computing devices, such as desktop computing devices, notebook computing devices, netbook computing devices, gaming devices, and the like. Other types of electronic devices may also be used. Furthermore, the user device 408 can include a camera or can interface with a camera for the visual detection of glyphs or a prescription pill bottle. Also, the user device 408 can include a display (e.g. a touch screen) that can display additional information about a prescription drug in augmented reality. Additionally or alternatively, the user device 408 can execute an application that may use a cellular phone function of the user device 408. The application may include instructions that when executed on the user device 408, in the benefit manager device 402, or pharmacy device 406, cause a machine to change its state or perform tasks within the machine and with other machines.

The member may have a copayment for the prescription drug that reflects an amount of money that the member is responsible to pay the pharmacy for the prescription drug. This copayment (or copay) may be dictated by the benefit plan output by the model 118 described above. The money paid by the member to the pharmacy may come from, as examples, personal funds of the member, a health savings account (HSA) of the member or the member's family, a health reimbursement arrangement (HRA) of the member or the member's family, or a flexible spending account (FSA) of the member or the member's family. In some instances, an employer of the member may directly or indirectly fund or reimburse the member for the copayments.

The amount of the copayment required by the member may vary across different pharmacy benefit plans created by the model 118 and having different plan sponsors or clients and/or for different prescription drugs. The member's copayment may be a flat copayment (in one example, $10), coinsurance (in one example, 10%), and/or a deductible (for example, responsibility for the first $500 of annual prescription drug expense, etc.) for certain prescription drugs, certain types and/or classes of prescription drugs, and/or all prescription drugs. The copayment may be stored in the storage device 410 or determined by the benefit manager device 402.

In some instances, the member may not pay the copayment or may only pay a portion of the copayment for the prescription drug. For example, if a usual and customary cost for a generic version of a prescription drug is $4, and the member's flat copayment is $20 for the prescription drug, the member may only need to pay $4 to receive the prescription drug. In another example involving a worker's compensation claim, no copayment may be due by the member for the prescription drug.

In addition, copayments may also vary based on different delivery channels for the prescription drug. For example, the copayment for receiving the prescription drug from a mail order pharmacy location may be less than the copayment for receiving the prescription drug from a retail pharmacy location.

In conjunction with receiving a copayment (if any) from the member and dispensing the prescription drug to the member, the pharmacy submits a claim to the PBM for the prescription drug. After receiving the claim, the PBM (such as by using the benefit manager device 402) may perform certain adjudication operations according to the benefit plan output by the model 118. These operations can include verifying eligibility for the member, identifying/reviewing an applicable formulary for the member to determine any appropriate copayment, coinsurance, and deductible for the prescription drug, and performing a drug utilization review (DUR) for the member. Further, the PBM may provide a response to the pharmacy (for example, the system 120) following performance of at least some of the aforementioned operations.

As part of the adjudication, a plan sponsor (or the PBM on behalf of the plan sponsor) ultimately reimburses the pharmacy for filling the prescription drug when the prescription drug was successfully adjudicated. The aforementioned adjudication operations generally occur before the copayment is received and the prescription drug is dispensed. However in some instances, these operations may occur simultaneously, substantially simultaneously, or in a different order. In addition, more or fewer adjudication operations may be performed as at least part of the adjudication process.

The amount of reimbursement paid to the pharmacy by a plan sponsor and/or money paid by the member may be determined at least partially based on types of pharmacy networks in which the pharmacy is included. In some implementations, the amount may also be determined based on other factors. For example, if the member pays the pharmacy for the prescription drug without using the prescription or drug benefit provided by the PBM, the amount of money paid by the member may be higher than when the member uses the prescription or drug benefit. In some implementations, the amount of money received by the pharmacy for dispensing the prescription drug and for the prescription drug itself may be higher than when the member uses the prescription or drug benefit. Some or all of the foregoing operations may be performed by executing instructions stored in the benefit manager device 402 and/or an additional device.

Examples of the network 404 include a Global System for Mobile Communications (GSM) network, a code division multiple access (CDMA) network, 3rd Generation Partnership Project (3GPP), an Internet Protocol (IP) network, a Wireless Application Protocol (WAP) network, or an IEEE 802.11 standards network, as well as various combinations of the above networks. The network 404 may include an optical network. The network 404 may be a local area network or a global communication network, such as the Internet. In some implementations, the network 404 may include a network dedicated to prescription orders: a prescribing network such as the electronic prescribing network operated by Surescripts of Arlington, Virginia. Moreover, although the system shows a single network 404, multiple networks can be used. The multiple networks may communicate in series and/or parallel with each other to link the devices 402 through 410.

The pharmacy device 406 may be a device associated with a retail pharmacy location (e.g., an exclusive pharmacy location, a grocery store with a retail pharmacy, or a general sales store with a retail pharmacy) or other type of pharmacy location at which a member attempts to obtain a prescription. The pharmacy may use the pharmacy device 406 to submit the claim to the PBM for adjudication through the benefit plan created by the system 100.

Additionally, in some implementations, the pharmacy device 406 may enable information exchange between the pharmacy and the PBM. For example, this may allow the sharing of member information such as drug history that may allow the pharmacy to better service a member (for example, by providing more informed therapy consultation and drug interaction information). In some implementations, the benefit manager device 402 may track prescription drug fulfillment and/or other information for users that are not members, or have not identified themselves as members, at the time (or in conjunction with the time) in which they seek to have a prescription filled at a pharmacy.

The pharmacy device 406 may include a pharmacy fulfillment device 412, an order processing device 414, and a pharmacy management device 416 in communication with each other directly and/or over the network 404. The order processing device 414 may receive information regarding filling prescriptions and may direct an order component to one or more devices of the pharmacy fulfillment device 412 at a pharmacy. The pharmacy fulfillment device 412 may fulfill, dispense, aggregate, and/or pack the order components of the prescription drugs in accordance with one or more prescription orders directed by the order processing device 414.

In general, the order processing device 414 is a device located within or otherwise associated with the pharmacy to enable the pharmacy fulfilment device 412 to fulfill a prescription and dispense prescription drugs. In some implementations, the order processing device 414 may be an external order processing device separate from the pharmacy and in communication with other devices located within the pharmacy.

For example, the external order processing device may communicate with an internal pharmacy order processing device and/or other devices located within the system 120. In some implementations, the external order processing device may have limited functionality (e.g., as operated by a user requesting fulfillment of a prescription drug), while the internal pharmacy order processing device may have greater functionality (e.g., as operated by a pharmacist).

The order processing device 414 may track the prescription order as it is fulfilled by the pharmacy fulfillment device 412. The prescription order may include one or more prescription drugs to be filled by the pharmacy. The order processing device 414 may make pharmacy routing decisions and/or order consolidation decisions for the particular prescription order. The pharmacy routing decisions include what device(s) in the pharmacy are responsible for filling or otherwise handling certain portions of the prescription order. The order consolidation decisions include whether portions of one prescription order or multiple prescription orders should be shipped together for a user or a user family. The order processing device 414 may also track and/or schedule literature or paperwork associated with each prescription order or multiple prescription orders that are being shipped together. In some implementations, the order processing device 414 may operate in combination with the pharmacy management device 416.

The order processing device 414 may include circuitry, a processor, a memory to store data and instructions, and communication functionality. The order processing device 414 is dedicated to performing processes, methods, and/or instructions described in this application. Other types of electronic devices may also be used that are specifically configured to implement the processes, methods, and/or instructions described in further detail below.

In some implementations, at least some functionality of the order processing device 414 may be included in the pharmacy management device 416. The order processing device 414 may be in a client-server relationship with the pharmacy management device 416, in a peer-to-peer relationship with the pharmacy management device 416, or in a different type of relationship with the pharmacy management device 416. The order processing device 414 and/or the pharmacy management device 416 may communicate directly (for example, such as by using a local storage) and/or through the network 404 (such as by using a cloud storage configuration, software as a service, etc.) with the storage device 410.

The storage device 410 and/or databases described herein may include: non-transitory storage (for example, memory, hard disk, CD-ROM, etc.) in communication with the benefit manager device 402 and/or the pharmacy device 406 directly and/or over the network 404. The non-transitory storage may store order data 418, member data 420, claims data 422, drug data 424, prescription data 426, and/or plan sponsor data 428. Further, the system 120 may include additional devices, which may communicate with each other directly or over the network 404.

The order data 418 may be related to a prescription order. The order data may include type of the prescription drug (for example, drug name and strength) and quantity of the prescription drug. The order data 418 may also include data used for completion of the prescription, such as prescription materials. In general, prescription materials include an electronic copy of information regarding the prescription drug for inclusion with or otherwise in conjunction with the fulfilled prescription. The prescription materials may include electronic information regarding drug interaction warnings, recommended usage, possible side effects, expiration date, date of prescribing, etc. The order data 418 may be used by a high-volume fulfillment center to fulfill a pharmacy order.

In some implementations, the order data 418 includes verification information associated with fulfillment of the prescription in the pharmacy. For example, the order data 418 may include videos and/or images taken of (i) the prescription drug prior to dispensing, during dispensing, and/or after dispensing, (ii) the prescription container (for example, a prescription container and sealing lid, prescription packaging, etc.) used to contain the prescription drug prior to dispensing, during dispensing, and/or after dispensing, (iii) the packaging and/or packaging materials used to ship or otherwise deliver the prescription drug prior to dispensing, during dispensing, and/or after dispensing, and/or (iv) the fulfillment process within the pharmacy. Other types of verification information such as barcode data read from pallets, bins, trays, or carts used to transport prescriptions within the pharmacy may also be stored as order data 418.

The member data 420 includes information regarding the members associated with the PBM. This information can be demographic information and may be stored in the member database 112. The information stored as member data 420 may include personal information, personal health information, protected health information, etc. Examples of the member data 420 include name, address, telephone number, e-mail address, prescription drug history, etc. The member data 420 may include a plan sponsor identifier that identifies the plan sponsor associated with the member and/or a member identifier that identifies the member to the plan sponsor. The member data 420 may include a member identifier that identifies the plan sponsor associated with the user and/or a user identifier that identifies the user to the plan sponsor. The member data 420 may also include dispensation preferences such as type of label, type of cap, message preferences, language preferences, etc. In addition, the member data 420 can include or reference prescription numbers associated with the member.

The member data 420 may be accessed by various devices in the pharmacy (for example, the high-volume fulfillment center, etc.) to obtain information used for fulfillment and shipping of prescription orders. In some implementations, an external order processing device operated by or on behalf of a member may have access to at least a portion of the member data 420 for review, verification, or other purposes.

In some implementations, the member data 420 may include information for persons who are users of the pharmacy but are not members in the pharmacy benefit plan being provided by the PBM. For example, these users may obtain drugs directly from the pharmacy, through a private label service offered by the pharmacy, the high-volume fulfillment center, or otherwise. In general, the use of the terms “member” and “user” may be used interchangeably.

The claims data 422 can be stored in the claims database 106 and can include information regarding pharmacy claims adjudicated by the PBM under a drug benefit program provided by the PBM for one or more plan sponsors. In general, the claims data 422 includes an identification of the client that sponsors the drug benefit program under which the claim is made, and/or the member that purchased the prescription drug giving rise to the claim, the prescription drug that was filled by the pharmacy (e.g., the national drug code number, etc.), the dispensing date, generic indicator, generic product identifier (GPI) number, medication class, the cost of the prescription drug provided under the drug benefit program, the copayment/coinsurance amount, rebate information, and/or member eligibility, etc. Additional information may be included.

In some implementations, other types of claims beyond prescription drug claims may be stored in the claims data 422. For example, medical claims, dental claims, wellness claims, or other types of health-care-related claims for members may be stored as a portion of the claims data 422.

In some implementations, the claims data 422 includes claims that identify the members with whom the claims are associated. Additionally or alternatively, the claims data 422 may include claims that have been de-identified (that is, associated with a unique identifier but not with a particular, identifiable member).

Furthermore, the claims data 422 can include or reference past prescriptions associated with previous refills, if any, of a prescription drug, how many pills or doses of the prescription drug are in each refill for the member, a last refill date (i.e. when the prescription drug was last refilled), a doctor who prescribed the prescription drug, and contact information for the doctor who prescribed the prescription drug. In some embodiments, the claims data 422 can predict how many pills or doses remain in the prescription based on a current date, the last refill date, and prescription dosing instructions. For example, if the prescription fill included 30 pills to be taken daily, the prescription was filled on Jan. 1, 2018, and the current date is Jan. 15, 2018, the claims data 422 can predict that 15 pills remain. In some embodiments, the claims data 422 and the number of pills or doses remaining are updated upon receiving indication that the member took or used the prescription drug. For example, a reminder application can receive an indication that the drug was used by the member over the network 404.

The drug data 424 may include drug names (e.g., technical name and/or common name), other names by which the drug is known, active ingredients, an image of the drug (such as in pill form), typical dosing instructions, etc. The drug data 424 may include information associated with a single medication or multiple medications. However, dosing instructions may come from the claims data 422 if the doctor prescribed dosing instructions different from the typical dosing instructions.

The prescription data 426 may include information regarding prescriptions that may be issued by prescribers on behalf of users, who may be members of the pharmacy benefit plan—for example, to be filled by a pharmacy. Examples of the prescription data 426 include usernames, medication or treatment (such as lab tests), dosing information, etc. The prescriptions may include electronic prescriptions or paper prescriptions that have been scanned. In some implementations, the dosing information reflects a frequency of use (e.g., once a day, twice a day, before each meal, etc.) and a duration of use (e.g., a few days, a week, a few weeks, a month, etc.).

Furthermore, the drug interaction data 430 can include all known interactions between various prescription drugs. The known interactions can be negative, positive, or benign. Further still, the drug interaction data 430 can include known interactions between each prescription drug and over-the-counter drugs, known interactions between each prescription drug and vitamins or medical herbs (e.g. St. John's Wort), or known interactions between each prescription drug and commonly used substances, such as alcohol.

In some implementations, the order data 418 may be linked to associated member data 420, claims data 422, drug data 424, and/or prescription data 426.

The plan sponsor data 428 includes information regarding the plan sponsors of the PBM. Examples of the plan sponsor data 428 include company name, company address, contact name, contact telephone number, contact e-mail address, etc.

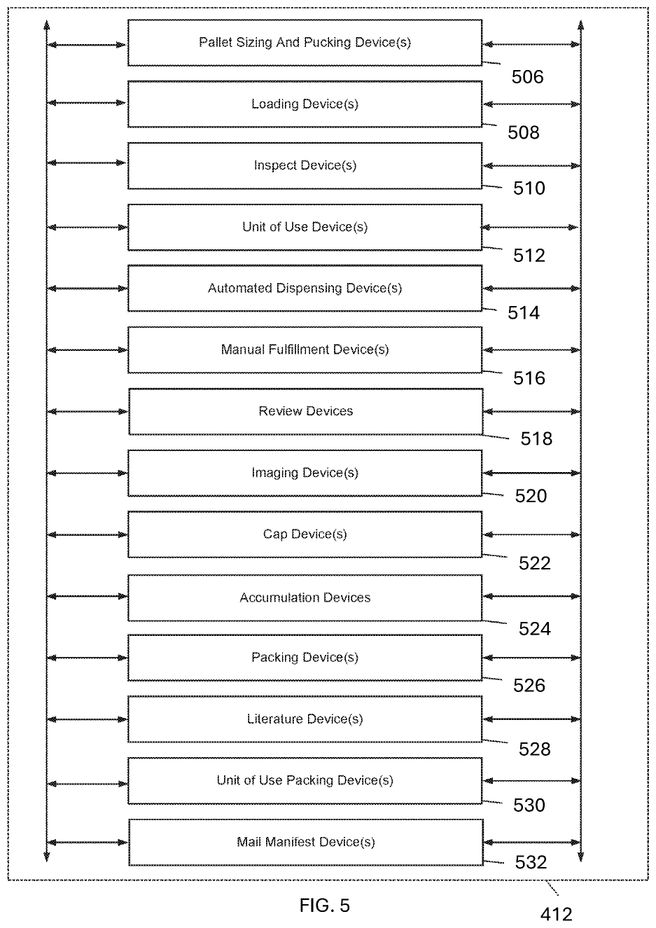

FIG. 5 illustrates the pharmacy fulfillment device 412 according to one example. The pharmacy fulfillment device 412 may be used to process and fulfill prescriptions and prescription orders according to the benefit plan output by the model 119. After fulfillment, the fulfilled prescriptions are packed for shipping.

The pharmacy fulfillment device 412 may include devices in communication with the benefit manager device 402, the order processing device 414, and/or the storage device 410, directly or over the network 404. Specifically, the pharmacy fulfillment device 412 may include pallet sizing and pucking device(s) 506, loading device(s) 508, inspect device(s) 510, unit of use device(s) 512, automated dispensing device(s) 514, manual fulfillment device(s) 516, review devices 518, imaging device(s) 520, cap device(s) 522, accumulation devices 524, packing device(s) 526, literature device(s) 528, unit of use packing device(s) 530, and mail manifest device(s) 532. Further, the pharmacy fulfillment device 412 may include additional devices, which may communicate with each other directly or over the network 404.

In some implementations, operations performed by one of these devices 506 through 532 may be performed sequentially, or in parallel with the operations of another device as may be coordinated by the order processing device 414. In some implementations, the order processing device 414 tracks a prescription with the pharmacy based on operations performed by one or more of the devices 506 through 532.

In some implementations, the pharmacy fulfillment device 412 may transport prescription drug containers, for example, among the devices 506 through 532 in the high-volume fulfillment center, by use of pallets. The pallet sizing and pucking device 506 may configure pucks in a pallet. A pallet may be a transport structure for a number of prescription containers, and may include a number of cavities. A puck may be placed in one or more than one of the cavities in a pallet by the pallet sizing and pucking device 506. The puck may include a receptacle sized and shaped to receive a prescription container. Such containers may be supported by the pucks during carriage in the pallet. Different pucks may have differently sized and shaped receptacles to accommodate containers of differing sizes, as may be appropriate for different prescriptions.

The arrangement of pucks in a pallet may be determined by the order processing device 414 based on prescriptions that the order processing device 414 decides to launch. The arrangement logic may be implemented directly in the pallet sizing and pucking device 506. Once a prescription is set to be launched, a puck suitable for the appropriate size of container for that prescription may be positioned in a pallet by a robotic arm or pickers. The pallet sizing and pucking device 506 may launch a pallet once pucks have been configured in the pallet.

The loading device 508 may load prescription containers into the pucks on a pallet by a robotic arm, a pick and place mechanism (also referred to as pickers), etc. In various implementations, the loading device 508 has robotic arms or pickers to grasp a prescription container and move it to and from a pallet or a puck. The loading device 508 may also print a label that is appropriate for a container that is to be loaded onto the pallet, and apply the label to the container. The pallet may be located on a conveyor assembly during these operations (e.g., at the high-volume fulfillment center, etc.).

The inspect device 510 may verify that containers in a pallet are correctly labeled and in the correct spot on the pallet. The inspect device 510 may scan the label on one or more containers on the pallet. Labels of containers may be scanned or imaged in full or in part by the inspect device 510. Such imaging may occur after the container has been lifted out of its puck by a robotic arm, picker, etc., or may be otherwise scanned or imaged while retained in the puck. In some implementations, images and/or video captured by the inspect device 510 may be stored in the storage device 410 as order data 418.

The unit of use device 512 may temporarily store, monitor, label, and/or dispense unit of use products. In general, unit of use products are prescription drug products that may be delivered to a user or member without being repackaged at the pharmacy. These products may include pills in a container, pills in a blister pack, inhalers, etc. Prescription drug products dispensed by the unit of use device 512 may be packaged individually or collectively for shipping, or may be shipped in combination with other prescription drugs dispensed by other devices in the high-volume fulfillment center.

At least some of the operations of the devices 506 through 532 may be directed by the order processing device 414 according to the benefit plan output by the model 118. For example, the manual fulfillment device 516, the review device 518, the automated dispensing device 514, and/or the packing device 526, etc. may receive instructions provided by the order processing device 414.

The automated dispensing device 514 may include one or more devices that dispense prescription drugs or pharmaceuticals into prescription containers in accordance with one or multiple prescription orders. In general, the automated dispensing device 514 may include mechanical and electronic components with, in some implementations, software and/or logic to facilitate pharmaceutical dispensing that would otherwise be performed in a manual fashion by a pharmacist and/or pharmacist technician. For example, the automated dispensing device 514 may include high-volume fillers that fill a number of prescription drug types at a rapid rate and blister pack machines that dispense and pack drugs into a blister pack. Prescription drugs dispensed by the automated dispensing devices 514 may be packaged individually or collectively for shipping, or may be shipped in combination with other prescription drugs dispensed by other devices in the high-volume fulfillment center.

The manual fulfillment device 516 controls how prescriptions are manually fulfilled. For example, the manual fulfillment device 516 may receive or obtain a container and enable fulfillment of the container by a pharmacist or pharmacy technician. In some implementations, the manual fulfillment device 516 provides the filled container to another device in the pharmacy fulfillment devices 412 to be joined with other containers in a prescription order for a user or member.

In general, manual fulfillment may include operations at least partially performed by a pharmacist or a pharmacy technician. For example, a person may retrieve a supply of the prescribed drug, may make an observation, may count out a prescribed quantity of drugs and place them into a prescription container, etc. Some portions of the manual fulfillment process may be automated by use of a machine. For example, counting capsules, tablets, or pills may be at least partially automated (such as through use of a pill counter). Prescription drugs dispensed by the manual fulfillment device 516 may be packaged individually or collectively for shipping, or may be shipped in combination with other prescription drugs dispensed by other devices in the high-volume fulfillment center.

The review device 518 may process prescription containers to be reviewed by a pharmacist for proper pill count, exception handling, prescription verification, etc. Fulfilled prescriptions may be manually reviewed and/or verified by a pharmacist, as may be required by state or local law. A pharmacist or other licensed pharmacy person who may dispense certain drugs in compliance with local and/or other laws may operate the review device 518 and visually inspect a prescription container that has been filled with a prescription drug. The pharmacist may review, verify, and/or evaluate drug quantity, drug strength, and/or drug interaction concerns, or otherwise perform pharmacist services. The pharmacist may also handle containers which have been flagged as an exception, such as containers with unreadable labels, containers for which the associated prescription order has been canceled, containers with defects, etc. In an example, the manual review can be performed at a manual review station.

The imaging device 520 may image containers once they have been filled with pharmaceuticals. The imaging device 520 may measure a fill height of the pharmaceuticals in the container based on the obtained image to determine if the container is filled to the correct height given the type of pharmaceutical and the number of pills in the prescription. Images of the pills in the container may also be obtained to detect the size of the pills themselves and markings thereon. The images may be transmitted to the order processing device 414 and/or stored in the storage device 410 as part of the order data 418.

The cap device 522 may be used to cap or otherwise seal a prescription container for medication prescribed and distributed according to the benefit plan output by the model 118. In some implementations, the cap device 522 may secure a prescription container with a type of cap in accordance with a user preference (e.g., a preference regarding child resistance, etc.), a plan sponsor preference, a prescriber preference, etc. The cap device 522 may also etch a message into the cap, although this process may be performed by a subsequent device in the high-volume fulfillment center.

The accumulation device 524 accumulates various containers of prescription drugs in a prescription order. The accumulation device 524 may accumulate prescription containers from various devices or areas of the pharmacy. For example, the accumulation device 524 may accumulate prescription containers from the unit of use device 512, the automated dispensing device 514, the manual fulfillment device 516, and the review device 518. The accumulation device 524 may be used to group the prescription containers prior to shipment to the member.

The literature device 528 prints, or otherwise generates literature to include with each prescription drug order. The literature may be printed on multiple sheets of substrates, such as paper, coated paper, printable polymers, or combinations of the above substrates. The literature printed by the literature device 528 may include information required to accompany the prescription drugs included in a prescription order, other information related to prescription drugs in the order, financial information associated with the order (for example, an invoice or an account statement), etc.

In some implementations, the literature device 528 folds or otherwise prepares the literature for inclusion with a prescription drug order (e.g., in a shipping container). In other implementations, the literature device 528 prints the literature and is separate from another device that prepares the printed literature for inclusion with a prescription order.

The packing device 526 packages the prescription order in preparation for shipping the order. The packing device 526 may box, bag, or otherwise package the fulfilled prescription order for delivery. The packing device 526 may further place inserts (e.g., literature or other papers, etc.) into the packaging received from the literature device 528. For example, bulk prescription orders may be shipped in a box, while other prescription orders may be shipped in a bag, which may be a wrap seal bag.

The packing device 526 may label the box or bag with an address and a recipient's name. The label may be printed and affixed to the bag or box, be printed directly onto the bag or box, or otherwise associated with the bag or box. The packing device 526 may sort the box or bag for mailing in an efficient manner (e.g., sort by delivery address, etc.) according to the benefit plan output by the model 118. The packing device 526 may include ice or temperature sensitive elements for prescriptions that are to be kept within a temperature range during shipping (for example, this may be necessary in order to retain efficacy). The ultimate package may then be shipped through postal mail, through a mail order delivery service that ships via ground and/or air (e.g., UPS, FEDEX, or DHL, etc.), through a delivery service, through a locker box at a shipping site (e.g., AMAZON locker or a PO Box, etc.), or otherwise.

The unit of use packing device 530 packages a unit of use prescription order in preparation for shipping the order. The unit of use packing device 530 may include manual scanning of containers to be bagged for shipping to verify each container in the order. In an example implementation, the manual scanning may be performed at a manual scanning station. The pharmacy fulfillment device 412 may also include a mail manifest device 532 to print mailing labels used by the packing device 526 and may print shipping manifests and packing lists.

While the pharmacy fulfillment device 412 is shown to include single devices 506 through 532, multiple devices may be used. When multiple devices are present, the multiple devices may be of the same device type or models, or may be a different device type or model. The types of devices 506 through 532 are example devices. In other configurations of the system 120, lesser, additional, or different types of devices may be included.

Moreover, multiple devices may share processing and/or memory resources. The devices 506 through 532 may be located in the same area or in different locations. For example, the devices 506 through 532 may be located in a building or set of adjoining buildings. The devices 506 through 532 may be interconnected (such as by conveyors), networked, and/or otherwise in contact with one another or integrated with one another (e.g., at the high-volume fulfillment center, etc.). In addition, the functionality of a device may be split among a number of discrete devices and/or combined with other devices.

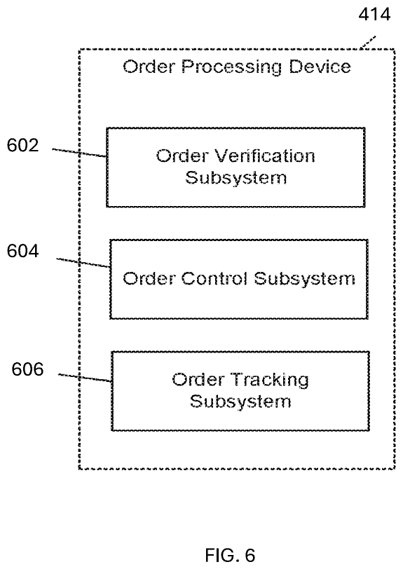

FIG. 6 illustrates one example of the order processing device 414 shown in FIG. 4. The order processing device 414 may be used by one or more operators to generate prescription orders, make routing decisions, make prescription order consolidation decisions, track literature with the system 120, and/or view order status and other order related information according to the benefit plan output by the model 118. For example, the prescription order may be comprised of order components.

The order processing device 414 may receive instructions to fulfill an order without operator intervention. An order component may include a prescription drug fulfilled by use of a container through the system 120. The order processing device 414 may include an order verification subsystem 602, an order control subsystem 604, and/or an order tracking subsystem 606. Other subsystems may also be included in the order processing device 414.

The order verification subsystem 602 may communicate with the benefit manager device 402 to verify the eligibility of the member and review the formulary to determine appropriate copayment, coinsurance, and deductible for the prescription drug and/or perform a DUR (drug utilization review) according to the benefit plan output from the model 118. Other communications between the order verification subsystem 602 and the benefit manager device 402 may be performed for a variety of purposes.

The order control subsystem 604 controls various movements of the containers and/or pallets along with various filling functions during their progression through the system 120. In some implementations, the order control subsystem 604 may identify the prescribed drug in one or more than one prescription order as capable of being fulfilled by the automated dispensing device 514. The order control subsystem 604 may determine which prescriptions are to be launched and may determine that a pallet of automated-fill containers is to be launched.

The order control subsystem 604 may determine that an automated-fill prescription of a specific pharmaceutical is to be launched and may examine a queue of orders awaiting fulfillment for other prescription orders, which will be filled with the same pharmaceutical. The order control subsystem 604 may then launch orders with similar automated-fill pharmaceutical needs together in a pallet to the automated dispensing device 514. As the devices 506 through 532 may be interconnected by a system of conveyors or other container movement systems, the order control subsystem 604 may control various conveyors: for example, to deliver the pallet from the loading device 508 to the manual fulfillment device 516 from the literature device 528, paperwork as needed to fill the prescription.

The order tracking subsystem 606 may track a prescription order during its progress toward fulfillment. The order tracking subsystem 606 may track, record, and/or update order history, order status, etc. The order tracking subsystem 606 may store data locally (for example, in a memory) or as a portion of the order data 418 stored in the storage device 410.

In one example, a method for creating a customized pharmacy benefit plan for a client using an AI system is provided. The method can include receiving, by the AI system, historical claims data from previous benefit plans; receiving, by the AI system, transcripts or recordings of meetings between a PBM and the client; receiving, by the AI system, survey data from members to gather member plan preferences and member plan requirements; and generating, by the AI system inputting the historical claims data, the transcripts or the recordings, and the survey data into a benefit plan model, the pharmacy benefit plan that dictates pharmacy benefits for the members.

The method can further include pressure testing the pharmacy benefit plan that is generated using one or more of hypothetical pharmacy claims or the historical claims data to calculate a plan impact on the client; and modifying the benefit plan model based on the plan impact that is calculated, wherein the benefit plan model that is modified generates a different benefit plan responsive to the same historical claims data, the same transcripts or recordings, and the same survey data.

The method can further include receiving, by the AI system, one or more legislative or regulatory requirements for benefit plan coverage, wherein the pharmacy benefit plan is generated by the AI system also inputting the one or more legislative or regulatory requirements into the benefit plan model. The method can further include receiving, by the AI system, forecasted future medication needs of the members, wherein the pharmacy benefit plan is generated by the AI system also inputting the forecasted future medication needs into the benefit plan model. The method can further include calculating the forecasted future medication needs of the members based on demographic data about the members.

The method can further include receiving, by the AI system, constraints on the benefit plan including a client profitability requirement, wherein the pharmacy benefit plan is generated by the AI system also inputting the constraints into the benefit plan model. The pharmacy benefit plan that is generated can include one or more medication co-pay amounts, deductible amounts, claim adjudication rules, covered medications, or covered medical treatments.

An ASIC for an ANN also is provided. The ASIC can include neurons organized in an array, each of the neurons including a register, a processing element, and at least one input; and synaptic circuits, each of the synaptic circuits including a memory for storing a synaptic weight, wherein each of the neurons is connected to at least one other of the neurons via at least one of the synaptic circuits. The processing elements of the neurons can be configured to receive historical claims data from previous benefit plans; receive transcripts or recordings of meetings between a PBM and the client; receive survey data from members to gather member plan preferences and member plan requirements; and generate the pharmacy benefit plan that dictates pharmacy benefits for the members by inputting the historical claims data, the transcripts or the recordings, and the survey data into a benefit plan model.

The processing elements of the neurons can pressure test the pharmacy benefit plan that is generated using one or more of hypothetical pharmacy claims or the historical claims data to calculate a plan impact on the client; and modify the benefit plan model based on the plan impact that is calculated, where the benefit plan model that is modified generates a different benefit plan responsive to the same historical claims data, the same transcripts or recordings, and the same survey data.

The processing elements of the neurons can receive one or more legislative or regulatory requirements for benefit plan coverage, where the pharmacy benefit plan is generated by the processing elements also inputting the one or more legislative or regulatory requirements into the benefit plan model. The processing elements of the neurons can receive forecasted future medication needs of the members, where the pharmacy benefit plan is generated by the processing elements also inputting the forecasted future medication needs into the benefit plan model. The processing elements of the neurons can calculate the forecasted future medication needs of the members based on demographic data about the members.

The processing elements of the neurons can receive constraints on the benefit plan including a client profitability requirement, where the pharmacy benefit plan is generated by the processing elements also inputting the constraints into the benefit plan model. The pharmacy benefit plan that is generated can include one or more medication co-pay amounts, deductible amounts, claim adjudication rules, covered medications, or covered medical treatments.

A machine-readable medium storing instructions for generating customized pharmacy benefit plans for clients also is provided. The instructions, when executed, can cause a machine to perform operations comprising receiving historical claims data from previous benefit plans; receiving transcripts or recordings of meetings between a pharmacy benefit manager (PBM) and the client; receiving legislative and regulatory requirements; receiving forecasted future medication needs based on demographic information; receiving survey data from members to gather their preferences and requirements; receiving constraints on the benefit plan, including profitability requirements and client-specific needs; processing the received data using an AI model 118 to generate a benefit plan, the benefit plan comprising co-pay amounts; deductible amounts; rules or criteria for adjudicating claims; lists of covered medications and treatments; prescription sizes; indications of whether medications can be mailed or must be picked up at a pharmacy; lists of approved pharmacies, healthcare providers, and distributors; pressure testing the generated benefit plan using hypothetical claims and demographic information to ensure cost-effectiveness and feasibility; and outputting the generated and pressure-tested benefit plan.

The historical claims data can include specific medication names, quantities, associated costs, patient demographics, and treatment outcomes. The transcripts or recordings of meetings can include specific client requirements, specific client preferences, and discussions on cost-saving measures and benefit optimizations. The legislative and regulatory requirements can include updates to state or federal regulations over time. The forecasted future medication needs can be based on demographic trends and emerging health conditions. The survey data can include member satisfaction ratings with current benefit plans and feedback on co-pay and deductible amounts.

The present systems and methods can process audio according to the U.S. Pat. No. 11,495,230, issued 8 Nov. 2022, which is hereby incorporated by reference. The present systems and methods can further automatically process database entries according to U.S. Pat. No. 11,947,629 issued 2 Apr. 2024, which is hereby incorporated by reference.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described examples (and/or aspects thereof) can be used in combination with each other. In addition, many modifications can be made to adapt a particular situation or material to the teachings of the various examples of the disclosure without departing from their scope. While the dimensions and types of materials described herein are intended to define the aspects of the various examples of the disclosure, the examples are by no means limiting and are exemplary examples. Many other examples will be apparent to those of skill in the art upon reviewing the above description. The scope of the various examples of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various examples of the disclosure, including the best mode, and also to enable any person skilled in the art to practice the various examples of the disclosure, including making and using any devices or systems and performing any incorporated methods. The patentable scope of the various examples of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A method for creating a customized pharmacy benefit plan for a client using an artificial intelligence (AI) system, the method comprising:
receiving, by the AI system, historical claims data from previous benefit plans;
receiving, by the AI system, transcripts or recordings of meetings between a pharmacy benefit manager (PBM) and the client;
receiving, by the AI system, survey data from members to gather member plan preferences and member plan requirements; and
generating, by the AI system inputting the historical claims data, the transcripts or the recordings, and the survey data into a benefit plan model, the pharmacy benefit plan that dictates pharmacy benefits for the members.

2. The method of claim 1, further comprising:
pressure testing the pharmacy benefit plan that is generated using one or more of hypothetical pharmacy claims or the historical claims data to calculate a plan impact on the client; and
modifying the benefit plan model based on the plan impact that is calculated, wherein the benefit plan model that is modified generates a different benefit plan responsive to the same historical claims data, the same transcripts or recordings, and the same survey data.

3. The method of claim 1, further comprising:
receiving, by the AI system, one or more legislative or regulatory requirements for benefit plan coverage, wherein the pharmacy benefit plan is generated by the AI system also inputting the one or more legislative or regulatory requirements into the benefit plan model.

4. The method of claim 1, further comprising:
receiving, by the AI system, forecasted future medication needs of the members, wherein the pharmacy benefit plan is generated by the AI system also inputting the forecasted future medication needs into the benefit plan model.

5. The method of claim 4, further comprising:
calculating the forecasted future medication needs of the members based on demographic data about the members.

6. The method of claim 1, further comprising:
receiving, by the AI system, constraints on the benefit plan including a client profitability requirement, wherein the pharmacy benefit plan is generated by the AI system also inputting the constraints into the benefit plan model.

7. The method of claim 1, wherein the pharmacy benefit plan that is generated includes one or more of medication co-pay amounts, deductible amounts, claim adjudication rules, covered medications, or covered medical treatments.

8. An application-specific integrated circuit (ASIC) for an artificial neural network (ANN), the ASIC comprising:
neurons organized in an array, each of the neurons including a register, a processing element, and at least one input; and
synaptic circuits, each of the synaptic circuits including a memory for storing a synaptic weight, wherein each of the neurons is connected to at least one other of the neurons via at least one of the synaptic circuits, the processing elements of the neurons configured to:
receive historical claims data from previous benefit plans;
receive transcripts or recordings of meetings between a pharmacy benefit manager (PBM) and a client;
receive survey data from members to gather member plan preferences and member plan requirements; and
generating a pharmacy benefit plan that dictates pharmacy benefits for the members by inputting the historical claims data, the transcripts or the recordings, and the survey data into a benefit plan model.

9. The ASIC of claim 8, wherein the processing elements of the neurons are configured to:
pressure test the pharmacy benefit plan that is generated using one or more of hypothetical pharmacy claims or the historical claims data to calculate a plan impact on the client; and
modify the benefit plan model based on the plan impact that is calculated, wherein the benefit plan model that is modified generates a different benefit plan responsive to the same historical claims data, the same transcripts or recordings, and the same survey data.

10. The ASIC of claim 8, wherein the processing elements of the neurons are configured to:
receive one or more legislative or regulatory requirements for benefit plan coverage, wherein the pharmacy benefit plan is generated by the processing elements also inputting the one or more legislative or regulatory requirements into the benefit plan model.

11. The ASIC of claim 8, wherein the processing elements of the neurons are configured to:
receive forecasted future medication needs of the members, wherein the pharmacy benefit plan is generated by the processing elements also inputting the forecasted future medication needs into the benefit plan model.

12. The ASIC of claim 11, wherein the processing elements of the neurons are configured to:
calculate the forecasted future medication needs of the members based on demographic data about the members.

13. The ASIC of claim 8, wherein the processing elements of the neurons are configured to:
receive constraints on the benefit plan including a client profitability requirement, wherein the pharmacy benefit plan is generated by the processing elements also inputting the constraints into the benefit plan model.

14. The ASIC of claim 8, wherein the pharmacy benefit plan that is generated includes one or more of medication co-pay amounts, deductible amounts, claim adjudication rules, covered medications, or covered medical treatments.

15. A machine-readable medium storing instructions for generating customized pharmacy benefit plans for clients, the instructions, which when executed, cause a machine to perform operations comprising:
receiving historical claims data from previous benefit plans;
receiving transcripts or recordings of meetings between a pharmacy benefit manager (PBM) and the client;
receiving legislative and regulatory requirements;
receiving forecasted future medication needs based on demographic information;
receiving survey data from members to gather their preferences and requirements;
receiving constraints on the benefit plan, including profitability requirements and client-specific needs;
processing the received data using an artificial intelligence (AI) model to generate a benefit plan, the benefit plan comprising:
co-pay amounts;
deductible amounts;
rules or criteria for adjudicating claims;
lists of covered medications and treatments;
prescription sizes;
indications of whether medications can be mailed or must be picked up at a pharmacy;
lists of approved pharmacies, healthcare providers, and distributors;
pressure testing the generated benefit plan using hypothetical claims and demographic information to ensure cost-effectiveness and feasibility;
outputting the generated and pressure-tested benefit plan.

16. The machine-readable medium of claim 15, wherein the historical claims data includes specific medication names, quantities, associated costs, patient demographics, and treatment outcomes.

17. The machine-readable medium of claim 15, wherein the transcripts or recordings of meetings include specific client requirements, specific client preferences, and discussions on cost-saving measures and benefit optimizations.

18. The machine-readable medium of claim 15, wherein the legislative and regulatory requirements include updates to state or federal regulations over time.

19. The machine-readable medium of claim 15, wherein the forecasted future medication needs are based on demographic trends and emerging health conditions.

20. The machine-readable medium of claim 15, wherein the survey data includes member satisfaction ratings with current benefit plans and feedback on co-pay and deductible amounts.
